(19) United States
(12) Patent Application Publication
(10) Pub. No.: US 2014/0013663 A1
(43) Pub. Date: Jan. 16, 2014

(54) MODULAR PLANTER BOX

(71) Applicant: Dimitri Shein, Anchorage, AK (US)

(72) Inventor: Dimitri Shein, Anchorage, AK (US)

(21) Appl. No.: 13/678,995

(22) Filed: Nov. 16, 2012

Related U.S. Application Data
(60) Provisional application No. 61/670,123, filed on Jul. 11, 2012.

(51) Int. Cl. A01G 9/02

(52) U.S. Cl. CPC A01G 9/02; E04B 1/54
USPC 47/66.1; 52/588.1; 29/428

(57) ABSTRACT

A modular planter box comprises a base panel coupled to at least four side panels to form an internal cavity for containing contents therein. The base panel includes attachment members coupled to the at least four side panels. The at least four side panels comprise a pair of opposing interlocking panels having female members and a pair of opposing support panels having male members. The female members are slidably coupled to the male members of the support panels and the attachment members of the base panel to form a collapsible, modular planter box.

### CROSS-REFERENCE TO RELATED APPLICATION

This application claims the benefit under 35 U.S.C. §119(e) of U.S. Provisional Patent Application No. 61/670,123 filed Jul. 11, 2012, where this provisional application is incorporated herein by reference in its entirety.

### BACKGROUND

1. Technical Field

The present invention relates to a planter box used to contain plants, trees, shrubs, soil, rocks, and the like. More specifically, a modular planter box includes a plurality of panels removably attached to one another by a plurality of male and female members slidably engaged to each other.

2. Description of the Related Art

Large planter boxes typically found on residential and commercial properties are cumbersome and expensive to manufacture and store. This is partially due to the inefficiencies during manufacture of such planter boxes, which requires numerous steps, machines, and parts to assemble. Once assembled, such planter boxes require much space to store and ship when fully assembled. These disadvantages contribute to the high cost of manufacturing, storing, and shipping of such fully assembled planter boxes.

Metal planter boxes, for example, are typically welded or permanently fastened together using a variety of machines, tools, fasteners, and other means of permanently constructing such boxes. These planter boxes, however, often suffer from structural integrity issues due to the load placed on the panels when the planter boxes are filled with contents. Furthermore, metal fasteners, such as sheet metal screws, tend to fail due to corrosion, thereby reducing the life of the planter box.

### BRIEF SUMMARY

In one embodiment a modular planter box comprises a base panel coupled to at least four side panels to form a collapsible container for holding contents therein. The base panel may include a planar surface having a pair of opposing male members and a pair of opposing attachment portions. The at least four side panels may comprise a first interlocking panel and a second interlocking panel opposing each other, and a first support panel and a second support panel similarly opposing each other. Said panels may be attached to each other by a plurality of male and female members that are slidably engaged to each other when the modular planter box is in an erected configuration.

The first and second support panels may each include a pair of opposing male connection members positioned vertically on left and right sides of each support panel for coupling to the first and second interlocking panels. The first and second support panels may further each include an attachment portion positioned on the lower end of each support panel for attachment to the base panel. The first and second interlocking panels may each include a pair of female members positioned vertically at left and right areas of each interlocking panel. Each female member may be slidably engaged or interfaced with one of the respective male members of the first and second support panels. The first and second interlocking panels may further each include a supplemental female member positioned horizontally on lower end portions of each interlocking panel. Each supplemental female member may be slidably interfaced with one of the pair of male members of the base panel. Thus, the first and second interlocking panels may be each slidably coupled to the first and second side panels and the base panel via a plurality of male and female members while the planter box is in the erected configuration. In another embodiment, the modular planter box includes first and second interlocking panels each comprising only two female members positioned on left and right sides of each interlocking panel. In this embodiment, a first and second support panels, having male members similar to that described above, are both attached to a base panel at a lower portion of the support panels. The female members of the first and second interlocking panels are then slidably engaged to respective male members on adjacent side panels from a lower side of the base panel.

In some embodiments, the at least four side panels (and associated male members) and the female members may each be formed from a unitary piece of material, such as sheet metal, polymer, plastic, or other suitable material. Accordingly, the female members may each include an attachment portion and a receiving portion. The attachment portion may be secured to an inner surface of one of the first and second interlocking panels. The receiving portion may be spatially positioned from the inner surface of the first and second interlocking panels in order to receive a respective male member, therefore providing a slidable coupling between the interlocking panels and the support panels.

In some embodiments, the first and second interlocking panels may each include a pair of end flanges formed on left and right ends of each of the first and second interlocking panels. The opposing end flanges are each slidably coupled to an outer surface of one of the first and second support panels to assist with providing rigidity to the planter box when in the erected configuration. This configuration also provides structural integrity by closely holding the support panels to the interlocking panels when in the erected configuration.

In some embodiments, the attachment portions of the first and second support panels are removably attached to one of the pair of attachment portions of the base panel by at least one fastening device, such as a sheet metal screw or similar fastening device to assist in reducing movement between the side panels and the base panel when in the erected configuration.

In a preferred embodiment, the base panel and at least four panels are comprised of sheet metal. The male members may be formed by a plurality of joggle bends such that the male members are formed inwardly and substantially perpendicular to the first and second support panels. Joggle bends are typically created using a sheet metal forming machine or handheld tool that bends at least a portion of a piece of sheet metal at a desired angle. The joggle bends of the panels of the modular planter may be at approximately a 90 degree angle relative to adjacent portions of sheet metal, but may be at different angles depending upon the desired configuration.

In some embodiments, the first and second support panels may each include an upper flange formed inwardly from the panel (e.g., formed by a joggle bend). Each upper flange may include a pair of slots positioned near opposing ends of the upper flange. Each slot may be adapted to slidably receive at least a portion of one of the female members when sliding at least one of the first and second interlocking panels into place when erecting the planter box. In some embodiments, the first and second support panels may each include a lower flange formed inwardly from the panel (e.g., formed by a joggle bend). Each lower flange may include a pair of slots positioned near opposing ends of the lower flange. Each slot may be adapted to slidably receive at least a portion of one of the female members when sliding the first and second interlocking panels into place, from a lower side of the base panel, when erecting the planter box.

In another embodiment, a method of forming a modular planter box comprises forming a base panel having a planar surface and adapted to couple to at least four side panels. The method may include forming the at least four side panels comprising a first interlocking panel, a second interlocking panel, a first support panel, and a second support panel, the first and second support panels each having a pair of male connection members. The first and second interlocking panels may each have a pair of female members to interface with the male members. The method may further include securing the first and second support panels to the base panel such that the first and second support panels are opposing each other and are substantially perpendicular relative to the planar surface of the base panel. The method may further include engaging each of the pair of female members of the first interlocking panel into one of the opposing male connection members of each of the first and second support panels. Concurrently or separately with the prior step, the method may include engaging each of the pair of opposing female members of the second interlocking panel into the other one of the opposing male connection members of the first and second support panels. The method may further include sliding the female members of the first and second interlocking panels along the male members of the first and second support panels to position the modular planter in the erected configuration. In some embodiments the method may further comprise engaging a pair of supplemental female members, each attached to respective first and second interlocking panels, into a pair of opposing male members of the base panel. The above steps may provide the at least four panels positioned in a substantially perpendicular position relative to the planar surface of the base panel and relative to an adjacent panel.

In some embodiments and before erecting the planter box, the method may comprise forming the male members inwardly such that the male members are substantially perpendicular to the base panel and adapted to receive the supplemental female members. The method may further comprise forming the pair of male members to be substantially perpendicular to the first and second support panels and adapted to receive respective female members. The method may further comprise forming the pair of opposing female members and the supplemental female member in the form of an S-shaped cross section such that the female members may be substantially similar to each other. The female members may be welded to the first and second interlocking panels in the positions described above. The method may further comprise forming a pair of end flanges on each panel to closely hold the panels to each other and to assist with providing rigidity to the planter box when in the erected configuration. The method may further comprise forming a slot in either an upper surface of an upper flange or a lower surface of a lower flange of each of the first and second support panels. The slots may then slidably receive the female members when engaging the pair of female members when erecting the planter box, whether from above or below the base panel.

When in the erected configuration, the modular planter box may be capable of moving to a collapsed configuration therefrom by repeating some or all of the steps above in an inverse manner.

### BRIEF DESCRIPTION OF THE SEVERAL VIEWS OF THE DRAWINGS

FIG. 1 is an isometric view of a planter box, according to one embodiment, in an erected configuration.

FIG. 2A is an elevational view of an interlocking panel of FIG. 1, according to one embodiment.

FIG. 2B is an isometric view of the interlocking panel of FIG. 2A, according to one embodiment.

FIG. 3 is an isometric view of a support panel of FIG. 1, according to one embodiment.

FIG. 4 is an isometric view of the base panel of FIG. 1, according to one embodiment.

FIG. 5A is a perspective view of sections of an interlocking panel and a support panel interlocked, according to one embodiment.

FIG. 5B is cross sectional view of the interlocking panel and the support panel of FIG. 5A, viewed along section 5B-5B, according to one embodiment.

FIG. 6 is an isometric view of a planter box, according to one embodiment, partially in an erected configuration.

FIG. 7 is an exploded view of a planter box according to one embodiment.

### DETAILED DESCRIPTION

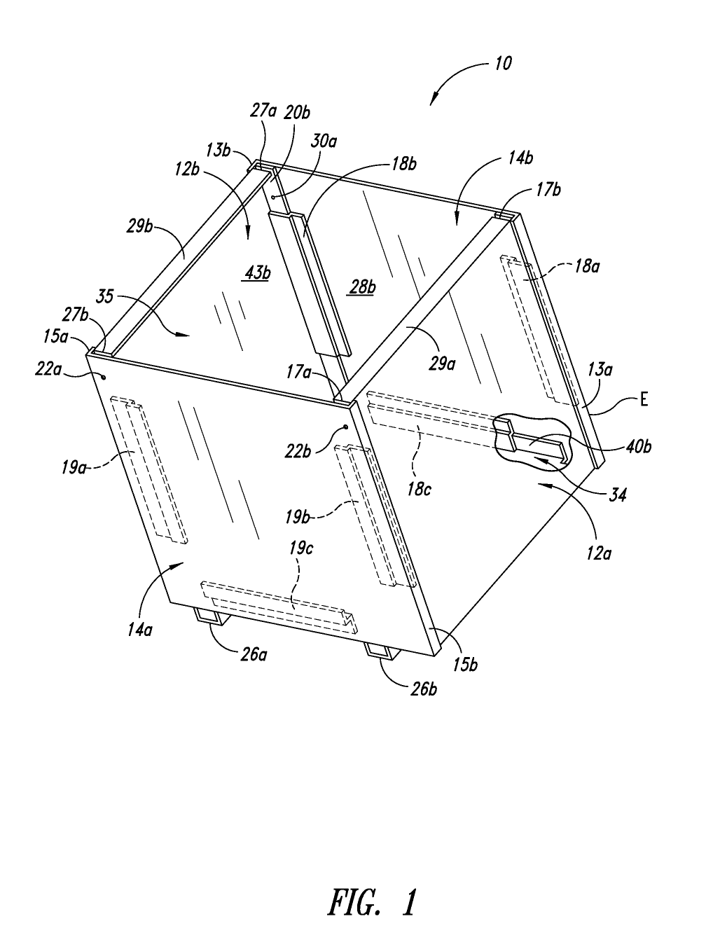

FIG. 1 shows an example embodiment of a modular planter box 10 having a base panel 34 coupled to at least four side panels 12a, 12b, 14a, 14b, defining an internal cavity 35, while in an erected configuration E. The at least four side panels comprise a first support panel 12a, a second support panel 12b, a first interlocking panel 14a, a second interlocking panel 14b, all coupled to each other and to the base panel 34. The first interlocking panel 14a includes a pair of female members 19a, 19b positioned vertically at right and left inner areas of the first interlocking panel 14a, respectively. The first interlocking panel 14a includes a supplemental female member 19c that interfaces with the base panel 34. Likewise, the second interlocking panel 14b includes a pair of female members 18a, 18b positioned vertically at left and right inner areas of the second interlocking panel 14b, respectively. The second interlocking panel 14b also includes a supplemental female member 18c that interfaces with a male member 40b of the base panel 34, as shown in the cutaway view in FIG. 1.

The support panels 12a, 12b include upper flanges 29a, 29b, respectively. As further described below, the upper flange 29a includes slots 17a, 17b that are sized to receive female members 18a, 19b, respectively. Likewise, the upper flange 29b includes slots 27a, 27b sized to receive female members 18b, 19a, respectively. As further discussed below, the interlocking panel 14b includes end flanges 13a, 13b, which “wrap around” outer surfaces of respective support panels 12a, 12b when the planter box is in the erected configuration. Likewise, interlocking panel 14a includes end flanges 15a, 15b, which “wrap around” outer surfaces of respective support panels 12b, 12a.

As further described below, each female member 18a, 18b, 18c, and 19a, 19b, 19c of the interlocking panels 14b, 14a is coupled to one of the male connection members of the support panels 12a, 12b and to one of the male connection members of the base panel 34. For example, female connection member 18b, attached to a planar surface 28b, is slidably coupled to a male connection member 20b of support panel 12b. The male connection member 20b may be formed inwardly and perpendicular relative to a planar surface 43b of the support panel 12b.

In some embodiments, the base panel 34 may include support members 26a, 26b to assist with supporting a load within the modular planter box 10 and to raise the planter box 10 above a surface upon which it rests when on a property. Additionally, as will be described below, a plurality of apertures may be formed through portions of the panels and the base panel, such as apertures 22a, 22b of the interlocking panel 14a. Likewise, apertures 30a, 30b (hidden) may be formed through portions of the support panels 12b, 12a, respectively. Such example apertures may be aligned with corresponding apertures through other components of the modular planter box 10 to receive a fastening device (such as a screw or bolt) to assist with providing rigidity to the modular planter box 10.

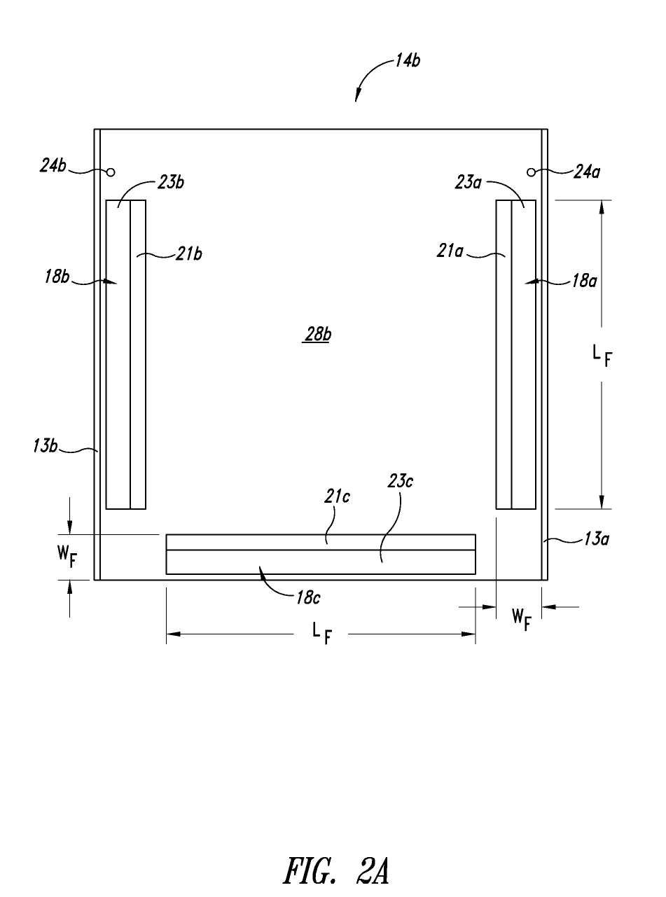

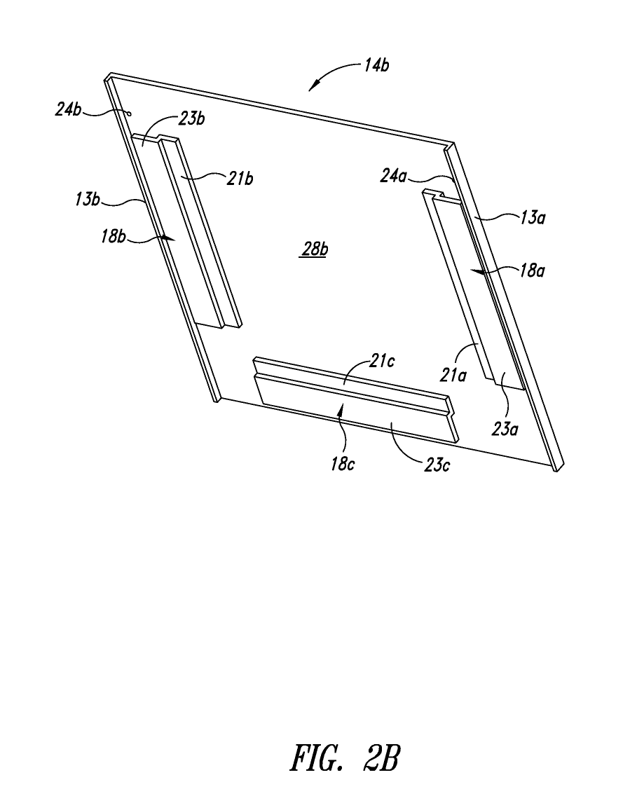

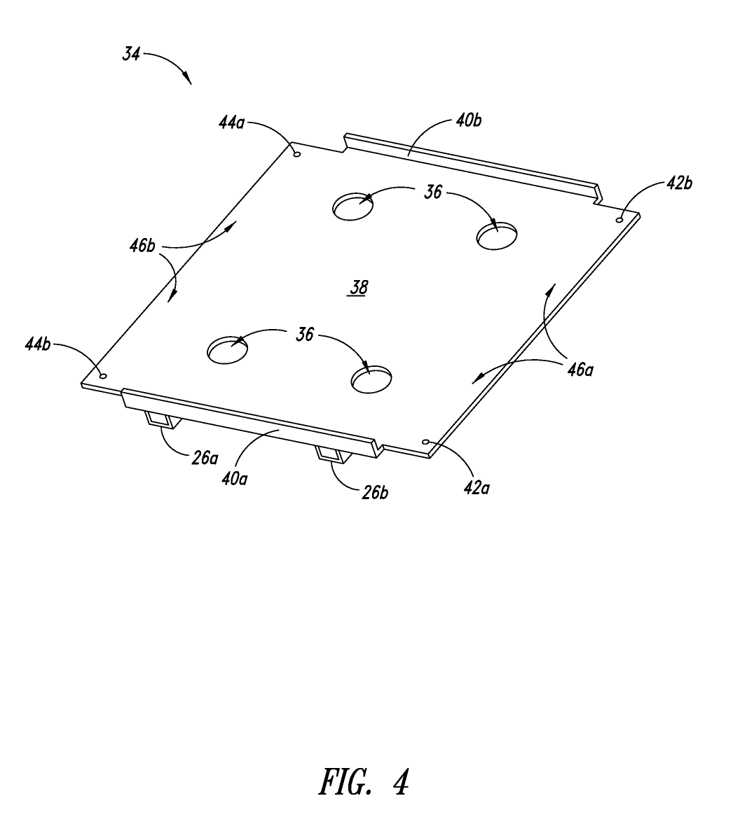

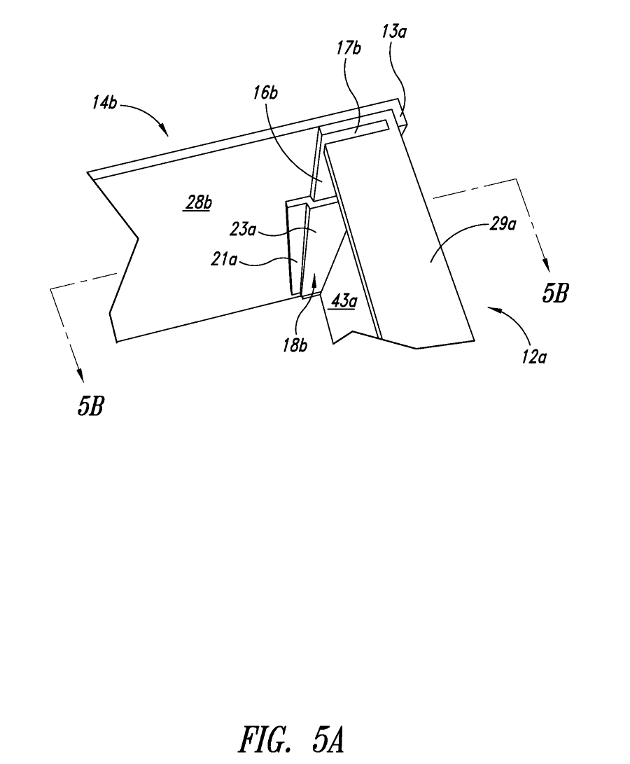

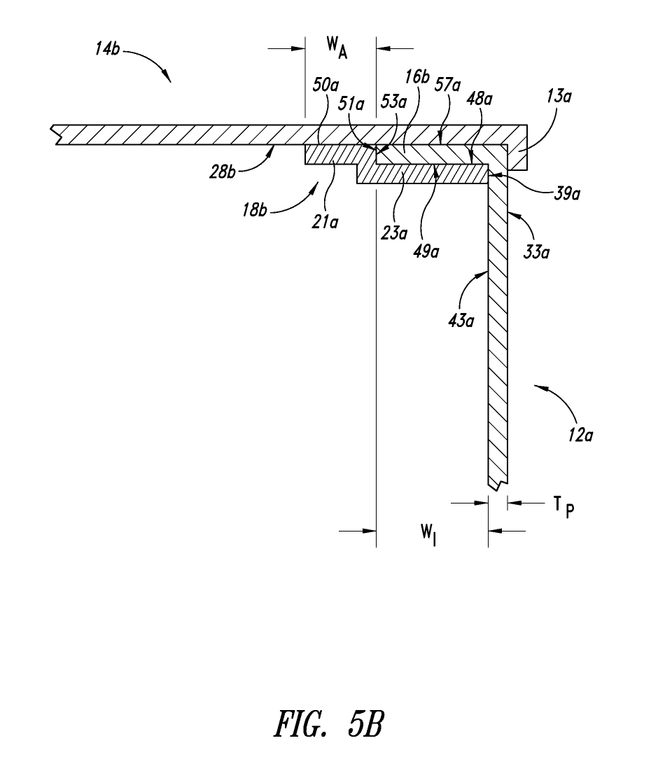

FIGS. 2A and 2B show the interlocking panel 14b shown in FIG. 1. The female members 18a, 18b are each attached to the planar surface 28b of the interlocking panel 14b and positioned substantially vertical relative to the base panel 34 and substantially parallel relative to each other. The supplemental female member 18c is positioned at a lower portion of the interlocking panel 14b and substantially horizontal relative to the base panel 34. Each female member 18a, 18b, 18c includes an attachment portion 21a, 21b, 21c and receiving portion 23a, 23b, 23c, respectively. The attachment portions 21a, 21b, 21c are attached to the planar surface 28b of the first interlocking panel 14b, such as by a weld or a fastener. The receiving portions 23a, 23b, 23c are spatially positioned away from the planar surface 28b in order to receive a respective male member from the support panels 12a, 12b (FIGS. 5A and 5B) and a respective male member 40a, 40b from the base panel 34 (FIGS. 1 and 4).

According to some embodiments, the interlocking panel 14b includes a pair of end flanges 13a, 13b formed inwardly on left and right ends of the interlocking panel 14b to assist with providing rigidity to the planter box 10 when in the erected configuration E (FIG. 1). Each female member 18a, 18b, 18c may have a length L_{F} of sufficient distance to provide rigidity to the planter box when under a load. Each female member 18a, 18b, 18c may have a width W_{F} of sufficient distance to provide rigidity to the planter box when under a load. Apertures 24a, 24b may be formed through the interlocking panel 14b and aligned with apertures in the support panels such that the aligned apertures receive a fastening device (such as a screw) to assist with providing rigidity to the modular planter box 10. It will be appreciated that the interlocking panel 14a may have the same or similar features of interlocking panel 14b, as shown in FIGS. 2A and 2B.

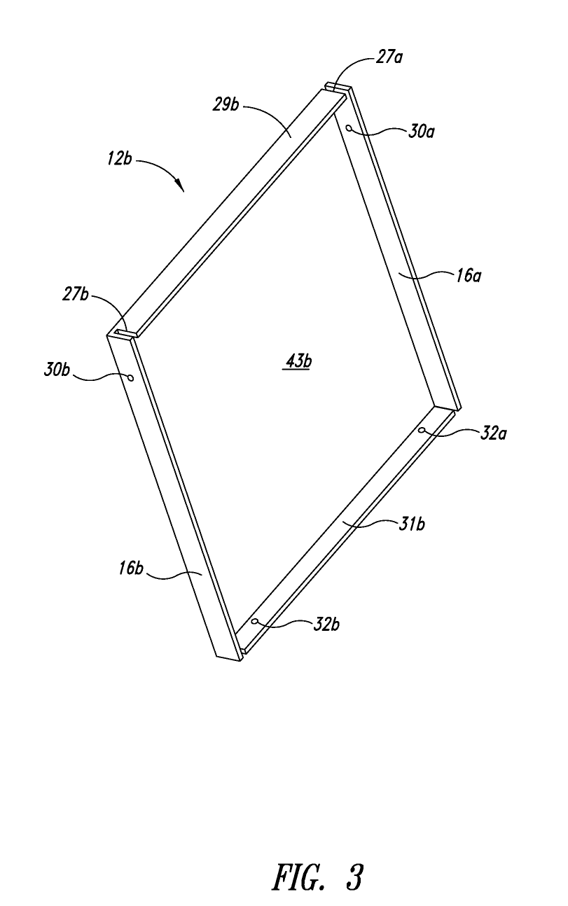

FIG. 3 shows support panel 12b having male members 16a, 16b formed on right and left ends of the panel, respectively. The male members 16a, 16b are formed inwardly from a planar surface 43b of the support panel 12b, such as by a joggle bend described above. The support panel 12b includes an upper flange 29b formed inwardly from the planar surface 43b. During manufacture, perimeter portions of the support panel 12b may be pre-cut such that when upper flange 29b is folded inwardly and male members 16a, 16b are folded inwardly (by a sheet metal machine or tool, for example) slots 27a, 27b are formed in the upper flange 29b. Thus, slots 27a, 27b may receive female members 18b, 19a of the interlocking panels 14b, 14a, respectively, when assembling the planter box 10. Similarly, the support panel 12b may include an attachment portion 31b at a lower end of the panel, which may also be pre-cut before the attachment portion 31b is folded inwardly to allow proper attachment to the base panel 34 at an attachment portion 46b (FIG. 4). Apertures 32a, 32b may be provided to align with apertures 44a, 44b of the base panel 34 to receive fastening devices for additional support to the planter box 10. Additionally, apertures 30a, 30b may be provided to align with apertures of the interlocking panels for the same purpose. It will be appreciated that the support panel 12a may have the same or similar features of the support panel 12b, as shown in FIG. 3.

FIG. 4 shows a base panel 34 having a planar surface 38 and a pair of opposing male members 40a, 40b which interface with the supplemental male members 19c, 18c, respectively (FIG. 1). The base panel 34 includes attachment portions 46a, 46b that couple to attachment portions 31a, 31b of the support panels 12a, 12b, respectively. The attachment portions 46a, 46b may be formed inwardly and perpendicular to the planar surface 38, similar to the male members 40a, 40b. The attachments portions 46a, 46b, as shown, may couple to the attachment portions 31a, 31b of the support panels 12a, 12b above or below the planar surface 38 of the base panel 34. In some embodiments, the base panel 34 includes at least one aperture 36 to allow egress of fluid from an internal cavity 35 of the modular planter box 10 when in the erected configuration E. In some embodiments, apertures 44a, 44b may align with apertures 32a, 32b of support panel 12b for receiving fasteners for additional support. Likewise, apertures 42a, 42b may align with apertures of support panel 12a for the same purpose.

FIGS. 5A and 5B show an example of the interface between which the interlocking panel 14b is coupled to the support panel 12a when the planter box is in the erected configuration, for example. With reference to FIG. 5A and as previously discussed, the support panel 12a includes an upper flange 29a that includes a slot 17b sized to receive the receiving portion 23a of the female member 18b. With particular reference to FIG. 5B, an attachment surface 50a of the female member 18b is attached to an inner surface 28b of the interlocking panel 14b. The interlocking panel 14b includes the end flange 13a extending substantially perpendicular from the planar surface 28b of the interlocking panel 14b. The end flange 13a is thus biased against an outer surface 33a of support panel 12a. The receiving portion 23a of the female member 18b includes an inner surface 48a biased against an inner surface 49a of the male member 16b. The male member 16b includes an end portion 51a biased against an inner portion 53a of the attachment portion 21a of the female member 18b. The male member 16b further includes an outer surface 57a biased against the planar surface 28b of the interlocking panel 14b. The receiving portion 23a further includes an end portion 39a biased against the planar surface 43a of the support panel 12a.

As shown best in FIG. 5B, the female member 18b has a cross-sectional area that is S-shaped (or Z-shaped depending upon the perspective view of the cross-sectional area). The receiving portion 23a may have a width W_{I} and the attachment portion 21a may have a width W_{A}, both of which may be a sufficient distance to provide a secure coupling between the interlocking panel 14b and the support panel 12a to assist with supporting a load within the planter box 10. The support panel 12a may have a thickness T_{P}, which may be within a range of a typical thickness of available sheet metal or other material comprising the planter box 10. The thickness of the based panel, the four support panels, and the male and female attachment portions, may also have the same or similar thickness T.

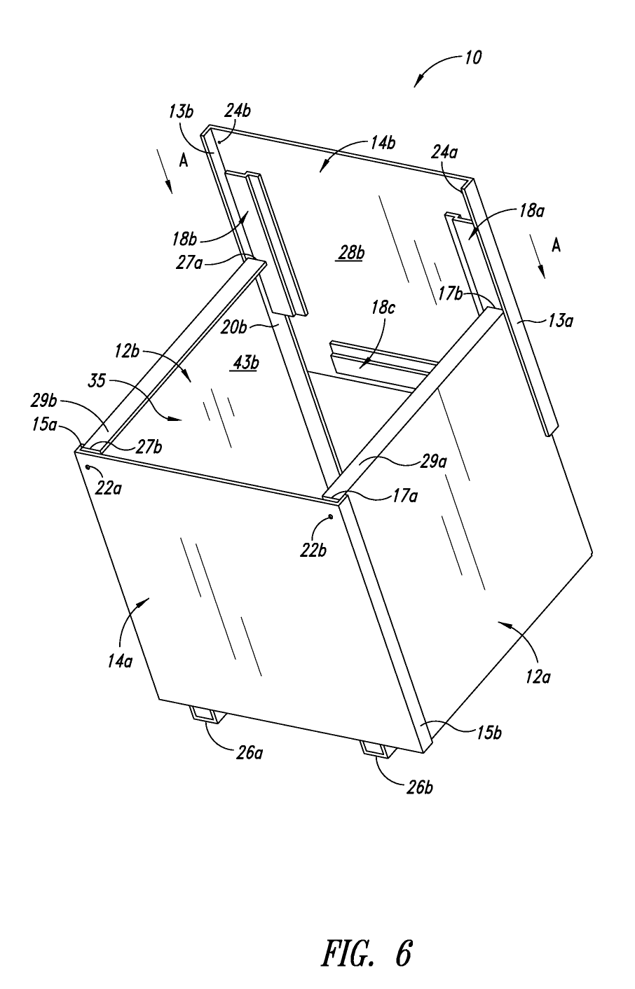

FIG. 6 shows the planter box 10, as shown in FIG. 1, for example, having the interlocking panel 14b partially installed. As discussed above, the interlocking panel 14b is installed by engaging the female member 18a into slot 17b of the support panel 12a, and engaging the female member 18b through slot 27a of the support panel 12b, in a downward direction depicted by arrows A. As the interlocking panel 14b is moved downward toward the base panel 34, the female member 18c is engaged to the male member 40b of the base panel 34

(FIG. 1). The interlocking panel 14a may also be installed in the same manner as the interlocking panel 14b to place the planter box 10 in the erected configuration E.

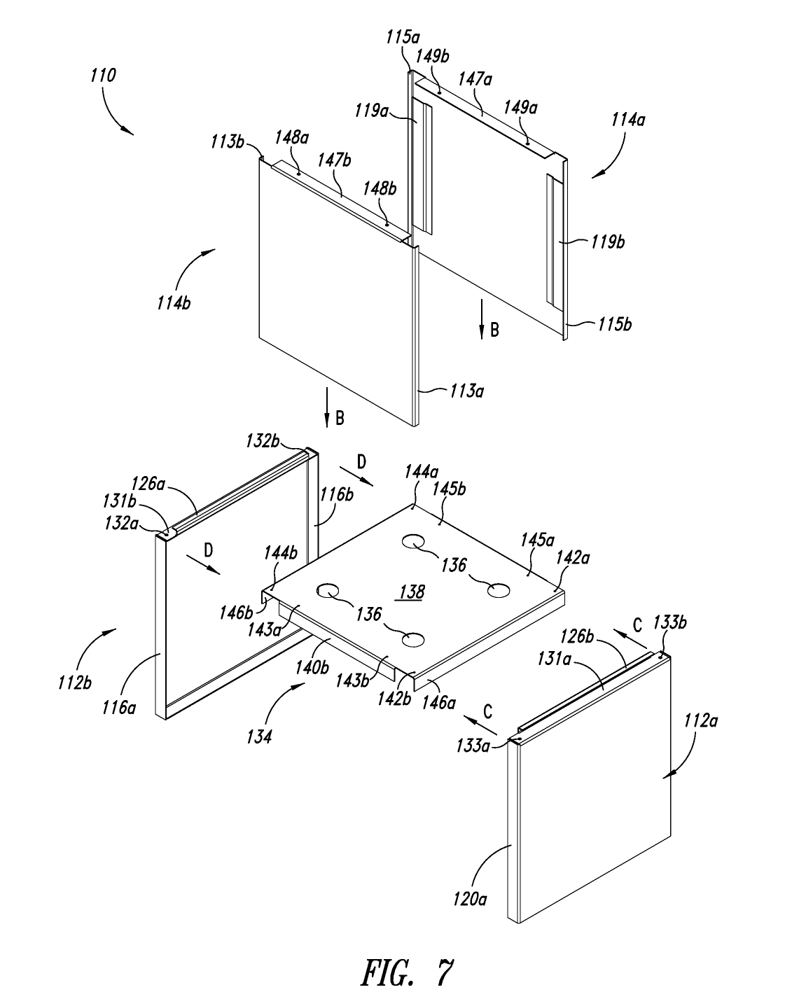

FIG. 7 shows an example embodiment of a modular planter box 110 having a base panel 134 and a first support panel 112a, a second support panel 112b, a first interlocking panel 114a, and a second interlocking panel 114b, all to be coupled to each other and to the base panel 34 when in an erected configuration. The support panel 112a includes lower flange 131a that interfaces with a planar surface 138 of base panel 134 when moved in the direction shown by arrows C when erecting the modular planter box 110. Thus, an attachment portion 146a of the base panel 134 is abutted against the inner surface of the support panel 112a when moved into position. Sheet metal screws may then be positioned through apertures 142a, 142b and apertures 133a, 133b, for example, for additional structural support. Likewise, the support panel 112b includes a lower flange 131b that interfaces with the planar surface 138 of base panel 134 when moved in the direction shown by arrows D when erecting the modular planter box 110. Thus, an attachment portion 146b of the base panel 134 is abutted against the inner surface of support panel 112b. Sheet metal screws may then be positioned through apertures 132a, 132b and apertures 144a, 144b, for example, for additional structural support.

The first interlocking panel 114a includes a pair of female members 119a, 119b positioned vertically at right and left inner areas of the first interlocking panel 114a, respectively. Likewise, the second interlocking panel 114b includes a pair of female members (hidden) positioned vertically at left and right inner areas of the second interlocking panel 114b. Similar to the above discussion with reference to the upper flange and slots of the support panels of FIGS. 1, 3, and 5A, the support panels 112a, 112b of FIG. 7 each include a respective lower flange 131a, 131b that each includes a pair of slots formed on left and right ends of the lower flanges 131a, 131b. The slots are sized to receive female members 118a, 118b, and 119a, 119b, respectively, when the first and second locking panels 114a, 114b are moved in the direction shown by arrows B, thereby slidably engaging the female members with the male members, similar to the description above regarding the embodiment of FIGS. 1-6. Once the first and second interlocking panels 114a, 114b are slid into place, lower attachment portions 147a, 147b are biased against with planar surface 138 of the base panel 134. Sheet metal screws may then be positioned through apertures 149a, 145a, and 149b, 145b, and through apertures 148a, 143a, and 148b, 143b, for example, for additional structural support.

As discussed above regarding FIGS. 1-6, the interlocking panel 114a includes end flanges 115a, 115b, which “wrap around” outer surfaces of respective support panels 112a, 112b when the planter box is in the erected configuration. Likewise, interlocking panel 114b includes end flanges 113a, 113b, which also “wrap around” outer surfaces of respective support panels 112b, 112a when the planter box is in the erected configuration. In some embodiments, the base panel 134 may include apertures 136 to allow egress of fluid from an internal cavity of the modular planter box 110 when in use. Additionally, support panels 112a, 112b may include support members 126a, 126b to assist with supporting a load within the modular planter box 110 and to raise the box above a surface upon which it rests when installed on a property.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A modular planter box, comprising:
a base panel having a planar surface;
at least four side panels coupled to the base panel to form the modular planter box, the at least four side panels comprising a first interlocking panel and a second interlocking panel opposing each other, and a first support panel and a second support panel opposing each other;
the first and second support panels each having a pair of opposing male connection members; and
the first and second interlocking panels each having a pair of opposing female members that are each slidably coupled to one of the opposing male connection members of the first and second support panels when the planter box is in an erected configuration.

2. The modular planter box of claim 1 wherein each of the first and second interlocking panels further include a supplemental female member positioned at a lower portion of each of the first and second interlocking panels, each lower female member slidably coupled to a male member of the base panel.

3. The modular planter box of claim 1 wherein each female member includes an attachment portion and a receiving portion, the attachment portion secured to an inner surface of each of the first and second interlocking panels, and the receiving portion biased against an inner surface of each of the male members of each of the first and second support panels when the planter box is in an erected configuration.

4. The modular planter box of claim 1 wherein the first and second interlocking panels each include a pair of end flanges, each of the pair of end flanges formed on left and right ends of each of the first and second interlocking panels, the opposing end flanges slidably coupled to an outer surface of each of the first and second support panels to assist with providing rigidity to the planter box when in the erected configuration.

5. The modular planter box of claim 1 wherein the first and second support panels each include an upper flange having a pair of slots, each the pair of slots oriented near opposing ends of the upper flange, wherein each slot is adapted to slidably receive at least a portion of one of the female members when positioning at least one of the first and second interlocking panels into the erected configuration.

6. The modular planter box of claim 1 wherein the base panel includes at least one aperture to allow egress of fluid from an internal cavity of the modular planter box when in the erected configuration.

7. The modular planter box of claim 1 wherein the at least four panels are comprised of sheet metal material, wherein the male members are formed by a plurality of inward joggle bends such that the male members are substantially perpendicular to the first and second support panels.

8. A side panel coupleable to a modular planter having a base panel and at least two support panels, the side panel comprising:
a side panel sheet having a planar surface;
a pair of female members attached to the planar surface on respective left and right portions of the planar surface, the pair of female members each having an attachment portion and a receiving portion, the attachment portion secured to the planar surface of the side panel sheet; and
each of the pair of female members having a slot defined by the receiving portion and a portion of the planar surface, each slot adapted to slidably receive a male portion of one of the at least two support panels of the modular planter such that the side panel sheet is removably attached to the modular planter.

9. The side panel of claim 8 wherein the side panel sheet comprises a supplemental female member attached to a lower area of the planar surface, the supplemental female member adapted to slidably receive a male portion of the base panel of the modular planter such that the side panel sheet is removably attached to the modular planter.

10. The side panel of claim 9 wherein the pair of female members are positioned vertically relative to the base panel, and wherein the supplemental female member is positioned horizontally relative to the base panel when the side panel is slidably coupled to the at least two support panels and the base panel.

11. The side panel of claim 9 wherein the pair of female members and the supplemental female member each include an S-shaped cross section.

12. The side panel of claim 9 wherein the side panel includes a pair of end flanges each formed on respective left and right ends of the side panel, the pair of end flanges formed substantially perpendicular to the planar surface, each of the end flanges adapted to slidably couple to one of the at least two support panels.

13. A method of erecting a modular planter, the method comprising:
forming a base panel having a planar surface and adapted to couple to at least four side panels;
forming the at least four side panels comprising a first interlocking panel, a second interlocking panel, a first support panel, and a second support panel, the first and second support panels each having a pair of male connection members, and the first and second interlocking panels each having a pair of female members;
securing the first and second support panels to the base panel such that the first and second support panels are opposing each other and are substantially perpendicular relative to the planar surface of the base panel;
engaging each of the pair of female members of the first interlocking panel into one of the opposing male connection members of each of the first and second support panels, and engaging each of the pair of opposing female members of the second interlocking panel into the other one of the opposing male connection members of the first and second support panels; and
sliding the female members of the first and second interlocking panels along the male members of the first and second support panels to position the modular planter in the erected configuration.

14. The method of claim 13 wherein sliding the female members further comprises engaging a supplemental female member into a male member of the base panel, wherein the first and second interlocking panels each include a supplemental female member on a lower end of each panel.

15. The method of claim 14 wherein forming the base panel further comprises forming the male members inwardly such that the male members are substantially perpendicular to the base panel and adapted to receive the supplemental female members.

16. The method of claim 13 wherein forming the first and second support panels further comprises forming the pair of male members to be substantially perpendicular to the first and second support panels and adapted to receive respective female members.

17. The method of claim 14 wherein forming the first and second interlocking panels further comprises forming the pair of opposing female members and the supplemental female member in the form of an S-shaped cross section such that the female members are substantially similar to each other.

18. The method of claim 13 wherein forming the first and second interlocking panels comprises forming a pair of end flanges on each panel, wherein the opposing end flanges are slidably coupled to the first and second support panels to assist with providing rigidity to the planter box when in the erected configuration.

19. The method of claim 13 wherein forming the first and second support panels comprises forming a slot in an upper surface of an upper flange or a lower surface of a lower flange of each of the first and second support panels, wherein the slots slidably receive the female members when engaging the pair of female members.

20. The method of claim 19 wherein sliding the female members comprises sliding the female members into either the slots on the upper flanges or the lower flanges of the first and second support panels.
